(19) United States
(12) Patent Application Publication
(10) Pub. No.: US 2017/0344716 A1
(43) Pub. Date: Nov. 30, 2017

(54) CONTEXT AND LOCATION SPECIFIC REAL TIME CARE MANAGEMENT SYSTEM

(71) Applicant: Interpreta, Inc, San Diego, CA (US)

(72) Inventors: Hatem A. Abou-Sayed, San Diego, CA (US); Ahmed F. Ghouri, San Diego, CA (US); Zoltan Papp, San Diego, CA (US); Benjamin Yu, San Diego, CA (US)

(21) Appl. No.: 15/169,689

(22) Filed: May 31, 2016

(51) Int. Cl. G06F 19/00; H04L 29/06

(52) U.S. Cl. CPC G06F 19/3418; H04L 63/10; H04L 63/08; G06F 19/323; G06F 19/327; G06F 19/325; G06F 19/328

(57) ABSTRACT

Described herein are technologies related to an implementation of a geolocation medical care management system that receives the physical locations of one or more patients from one or more communication devices, accesses personal medical data related to each of the patients and correlates the personal medical data to physical location of each of the patients. Depending on the where or location of a patient is in the process, particular care or service is provided to the patient.

### BACKGROUND

Current medical patient care is a comprehensive process which involves various parties relying on one another to provide accurate and up to date information as to patients. Not only are medical providers, such as doctors, nurses, pharmacists, etc. involved in the care of the patient, but administrators, government agencies, insurance providers, etc. are involved.

In order to provide the best medical care, time frame of providing care is needed. In other words, a patient may be treated for a particular ailment/disease which involves several steps in the treatment. Knowledge of where the patient is in the process is needed to properly treat the patient. Typically a patient has a medical appointment to attend to. Timely scheduling of the patient avoids unnecessary wait time. Often, a patient requires follow up treatment/service from another medical provider. Commonly, a prescription is needed after a visit/treatment, and a pharmacy must be contacted and prescriptions filled.

Data and software analytics are impacting all industries, including the medical field. Such analytics involve the importing, processing and interpreting large repositories of data. Furthermore, geolocation is increasingly important in creating, adding or evaluating context of human interaction with the environment and other persons/parties. In the field of health care, geolocation can provide context to the presentation, diagnosis, and treatment of disease as well as to the behaviors that impact health and wellness.

A patient's geolocation can provide information on personal behavior, co-location with providers, physical presence at a variety of points of care; example scenarios include such vectors as going to emergency room to operating room, emergency room to imaging facility, general practitioner to specialist, etc. In addition, a particular patient's location and pattern of movement can identify public health risk (e.g., location of a potentially contagious patient in regards to the public). Furthermore, accurately and timely knowing a patient's location can assist in diagnostic, treatment and other medical care for the patient.

### BRIEF DESCRIPTION OF THE DRAWINGS

FIG. 1 illustrates an example scenario showing an overview of geolocation medical care management system as described herein.

FIG. 2 illustrates an example operation set for gathering patient medical data as described herein.

FIG. 3 illustrates an example system that implements context-specific use of patient and provider information as described in present implementations herein.

FIG. 4 illustrates an example screen-shot in a user-device in response to a detected geolocation of the user-device as described herein.

FIG. 5 illustrates an exemplary process for configuring a device memory as described in present implementations herein.

FIG. 6 illustrates an exemplary process for implementing a method for a clinical-context aware precision medical care management as described herein.

FIG. 7 illustrates an exemplary computer system that implements the processes and techniques described herein.

### DETAILED DESCRIPTION

Described herein are technologies relating to context-specific use of medical data information between a user (e.g., patient) and an observer (e.g., healthcare personnel). Particularly, a method described herein demonstrates providing of timely precision medical care using a detected geolocation of the patient. With the detected geolocation of the patient, delivery of medical data—temporal information with context-specific alerting is communicated to the patient.

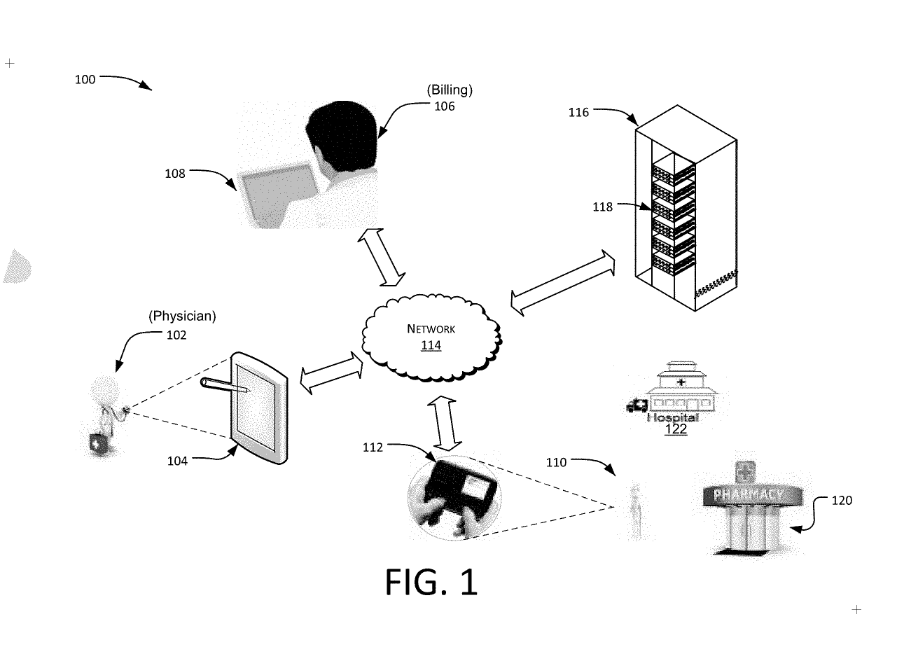

FIG. 1 illustrates an example scenario 100 showing an overview of context-specific use of patient and provider information to provide, for example, one or more patients with timely precision medical care. Particularly, the scenario 100 illustrates a method, system and apparatus for using a geolocation of a patient, a provider or ancillary healthcare personnel in selection, delivery and assessment of care with context-specific alerting.

Scenario 100 shows a healthcare personnel 102 (e.g., medical doctor) with a mobile device 104 (e.g., cellphone, iPad, etc.), a billing—healthcare personnel 106 (e.g., accountant) with a (laptop) device 108, a patient-user 110 (hereinafter referred to as patient 110) holding a user-device 112, a network 114, and a database or data structure 116 that stores digital patient medical database segments 118 (e.g., modules). The arrangement in scenario 100 further illustrates, for example, a detection of the patient's geolocation from a nearby pharmacy 120 or a hospital 122.

As an overview of the scenario 100, a software program and/or hardware implementations as described herein, for example, perform detection of a geolocation, identification, authentication, etc. of the user-device 112 and of the patient 110. Based from this detection, a search is performed on the associated digital patient medical database segments 118 for temporal information related to patient—prescription alert such as buying medicine prescription at the nearby pharmacy 120, medical advice—alert such as presence of high allergy in the area, medical recommendations such as an urgent need to have an X-ray at the nearby hospital 122, and the like. Similarly, the healthcare personnel 102 who may be a primary physician of the patient 110, accountant 106 who is in charge of billing insurance company of the patient 110, etc. may similarly be alerted with regard to transactions and/or communications from the patient 110, prescription alerts that were complied by the patient 110, etc. These prescription alerts, requirements and instructions to patient and healthcare personnel, recommendations to the patient, and the like, may be configured and/or stored onto the digital patient medical database segments 118, which may include one or more modules to store, but is not limited to, temporal medical data information of the patient 110. In certain instances, health care costs and values are provided. As an example, an alert may be provided for a high cost procedure and/or medication.

Other examples of alerts include, but are not limited to the following. An alert to indicate that the patient was reported in a medical claim to have had care on a date of service at a place of service but the geolocation data does not corroborate this (i.e., a potential fraudulent or erroneous claim).

An alert to indicate the duration of an encounter was more or less than the amount of time reflected on a claim that uses billing codes based on the time the patient should have or was required to spend in a face-to-face encounter with a healthcare provider.

An alert to indicate that a patient's geolocation in a certain point of service is not warranted by the clinical context provided in medical record or claims information, e.g. a medical claim filed for a provider type for a billing code that is not appropriate for the specialty type.

An alert to indicate poor time management if a patient's geolocation should be expected to change within a certain timeframe but is not changing.

An alert to indicate the tool or system used to monitor the geolocation is not corroborated by other information (e.g., social media check-ins/reports, location-based photographs or other location/time-stamped data from external sources), suggesting the patient is not in fact physically present despite what the geolocation system may indicate.

An alert to indicate that a provider is not present at the time and place that the patient's geolocation system indicates for the patient, when an insurance claim or medical record claims to place the provider there.

Upon the detection of the geolocation of the patient 110, a display screen of the user-device 112 presents a received listing of digital patient medical database segments that may correspond or associated to present time, day, duration of presence, and geolocation of the patient 110. In this example, the listing of digital patient medical database segments is obtained from the digital patient medical database segments 118 from the data structure 116. In another example, the listing of digital patient medical database segments 118 may be derived from the user-device itself. In these examples, the listing of digital patient medical database segments 118 are filtered by the software program to correspond with the present time, day, duration of presence, and geolocation of the patient 110.

In an embodiment, the listing of digital patient medical database segments 118 may include a real-time alert to the patient 110 such as prescription alert, allergy warning alert, a recommended presence of nearby pharmacy 120, and the like. Similarly, the listing of digital patient medical database segments 118 may include a notice to the healthcare personnel 102, the accountant 106, and other parties (not shown) that may have an interest with regard to the geolocation and/or present transaction with the patient 110.

With the presented listing of digital patient medical database segments, the patient 110 has the option of choosing one or more data from the presented digital patient medical database segments. For example, the patient 110 selects a particular data based from its importance and urgency such as the need to buy a prescribed medicine at the nearby pharmacy 120. In this example, the user-device 112 may communicate the user selection through the network 114, and the corresponding digital patient medical database segment 118 that is associated to the patient 110 may be updated accordingly. In another example, the presented listing may include an alert to notify and/or call immediately the primary physician of the patient 110. In this other example, the patient 110 may merely read the alert and notify/call the primary physician if he so desires.

Although FIG. 1 shows a limited number of healthcare personnel such as the healthcare personnel 102 and the accountant 106, in reality, the network 114 may connect multitudes of healthcare personnel (through their devices) to multiple number of user-devices 112 or patients 110. Furthermore, an initiation and subsequent presentation of the listing of the digital patient medical database segments 118 to user-device 112 may not be limited to the present time, day, and geolocation of the patient 110. The initiation may be further based upon assessed recommendations, diagnosis, and other conditions other than being based from the present time, day and geolocation of the patient 110.

As an example of present implementations herein, the healthcare personnel 102 is not limited to individuals who are experts in medical field or healthcare expertise. For example, the healthcare personnel 102 may be a social worker, a personal injury lawyer, a guidance councilor, etc. who may have an interest with regard to temporal information and/or updated transaction of the patient 110.

The digital patient medical database segments 118 may further store one or more data such as, but is not limited to: patient's personal information records, patient's public health records, health insurance records, personal medical history records, personal medical care records, personal drug prescriptions records, pharmacopeia data records, healthcare organization and facilities information, health care content libraries, government information records, marketing information libraries, and genomic libraries

The network 114 is a generic label for remote services offered over a computer network (e.g., the Internet) that entrusts a user's data, software, and/or computation. For example, the healthcare personnel-device 104 connects to the user-device 112 through the network 114. In this example, the network 114 facilitates wired or wireless form of communications between the healthcare personnel-device 104 and the user-device 112.

The database structure 116 stores the digital patient medical database segments 118 that are associated to different patients 110. Furthermore, each digital patient medical database segment 118 is associated, for example, with an address to facilitate its retrieval during the implementation of the technology as described herein.

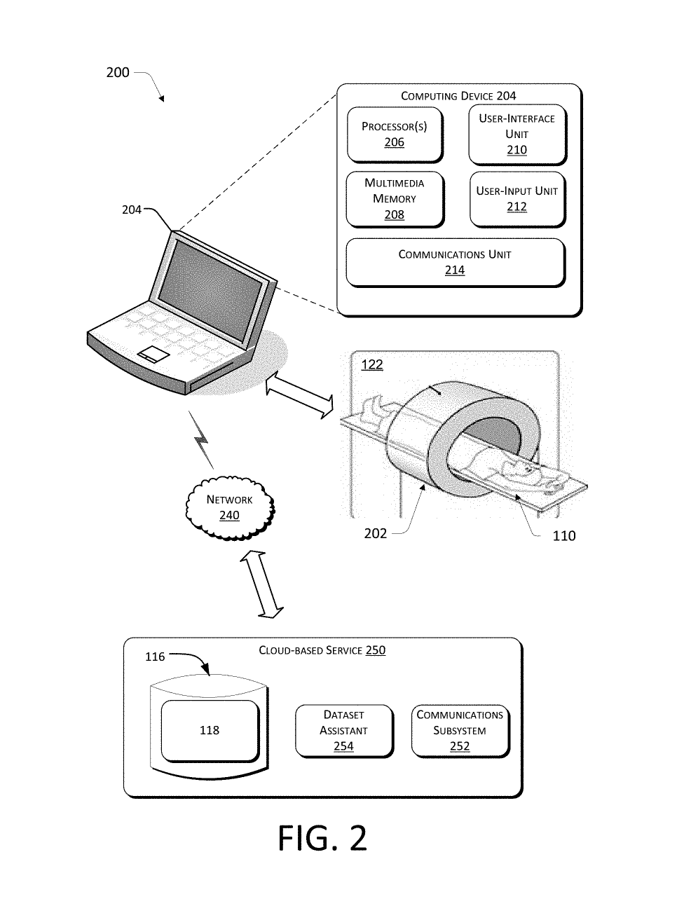

FIG. 2 is an example operation set 200 for gathering patient medical data that is to be stored on the data structure 116 as digital patient medical database segments 118. In particular, the operation set 100 depicts: a medical diagnosis performed by an example medical diagnosis tool 202 at the hospital 122 or any other healthcare provider facility; a computing device 204 that may operate the medical diagnosis tool 202; a network 240; and cloud-based service 250.

As depicted, the computing device 204 may further include one or more processor(s) 206 (or simply a processor), a multimedia memory 208, a user-interface unit 210, a user-input unit 212, and communications unit 214. These functional components may be separate or some combination of hardware units. Alternatively, the components may be implemented, at least in part, in software and thus be stored in the multimedia memory 208 and executed by the processors 206.

In an embodiment, the medical diagnosis tool 202 may perform magnetic resonance image (MRI) scanning of the patient 110 when the patient, for example, is in a “normal” state. The normal state can also be called healthy or balanced state. From the scan, one or more organs/tissues of the patient 110 may be identified, measured, sampled, etc. and stored as a baseline model for the normal patient 110 as depicted. The baseline model may be created from a single scan of one or more organs/tissues or from statistical analysis (e.g., mean or median) over several scans.

The baseline model together with other patient information such as medical doctor's observations/diagnosis, MRI technician's comments, and other related patient healthcare data may be stored as one or more data on the associated digital patient medical database segment 118 in the cloud-based service 250. Alternatively, the baseline model may be initially stored in the multimedia memory 208 and thereafter uploaded and integrated to digital patient medical database segment 118.

As an example illustration, a stored digital patient medical database segment 118 labeled as “Table-One” is shown below. In this example illustration, the patient information, baseline model, medical doctor observations, diagnosis alerts, conditions to activate alert, etc. are the data that were written inside the blocks (e.g., Patient Name, etc.) while the digital patient medical database segment is the Table-One itself.

TABLE ONE
(i.e., Digital patient medical database segment 118)

| | |
|---|---|
| Patient Name | John Doe; |
| Primary Physician | Healthcare Personnel 102 |
| Authentication Condition | Social Security Input and |
| | registered user-device number |
| Patient Authorization Status | Full Authorization/Disclosure |
| Present Health Status | Liver Problem |
| Alert Activation Condition | Patient is alerted when patient's |
| | geolocation is in nearby pharmacy |
| Billing Alert Condition | Activate alert to accountant when |
| | Patient selects “buying |
| | prescription” |
| SMS Alert Recipient When | John Doe - (222-222) |
| Patient's Geolocation is near | |
| Pharmacy, hospital, fitness center, | |
| etc. | |
| SMS Alert Primary Physician in | Dr. Jane - (333-222) |
| case the following conditions are | |
| present: patient selects buying | |
| prescription, patient ignores alert, | |
| visit to one or more healthcare | |
| locations, etc. | |
| Automatic alert schedule | Alert breakfast every morning |
| regardless of patient geolocation | |

Although the illustrated “Table One” as digital patient medical database segment 118 shows a few number of data and/or conditions, other data or multiple conditions may be further associated to the “Table One” as described herein.

In an embodiment, module partitions of the digital patient medical database segment 118 may be furthermore assigned with specific physical addresses to facilitate retrieval of the stored digital patient medical database segments. For example, the specific physical addresses can be in the form of a binary number to access the “Table-One” above. In this example, the “Table-One” can be of any size (e.g., one kilobytes) and it may depend upon the amount of the associated information therein.

Referencing back the computing device 204, the user-input unit 212 may receive patient medical data directly from the attending physician, MRI technician, etc. who enters manually the diagnosis or alternatively, the medical data is received directly from the medical diagnosis tool 202. The user-input unit 212, for example, utilizes the patient medical data to consult with the processor 202 in order to receive additional information from the digital patient medical database segment 118 (i.e., Table-One above) that may be stored in the data structure 116. In another example, the user-input unit 212 consults with the communication unit 214 to upload the patient medical data to the data structure 116 and particularly, the digital patient medical database segment 118 at cloud-based service 250.

As an example of current implementations herein, the network 240 may be a wired and/or wireless network. It may include the Internet infrastructure and it may be presented as the so-called “cloud.” The network 240 may include wired or wireless local area network, a cellular network, and/or the like. The network 240 links the computing device 204 with one or more network servers or cloud-based service 250.

The cloud-based service 250 includes a communications subsystem 252, a dataset assistant 254, and the digital patient medical database segments 118 that are stored at the data structure 116. The cloud-based service 250 need not be part of the so-called “cloud.” Rather, it may be described as one or more network servers or more simply as a computing system.

As shown, the communications subsystem 252 may facilitate receiving of data requests from the communication unit 214. For example, the data request by the attending technician or medical doctor relates to the temporal information of the patient 110 that are stored in the digital patient medical database segment 118. Similarly, the communications subsystem 252 facilitates the transmission of the retrieved temporal information back to the computing device 204.

The dataset assistant 254 responds to requests from the computing devices to access, for example, a particular digital patient medical database segment 118 of the particular patient 110. In this example, the dataset assistant 254 facilitates finding of the particular digital patient medical database segment 118 that corresponds to the patient 110.

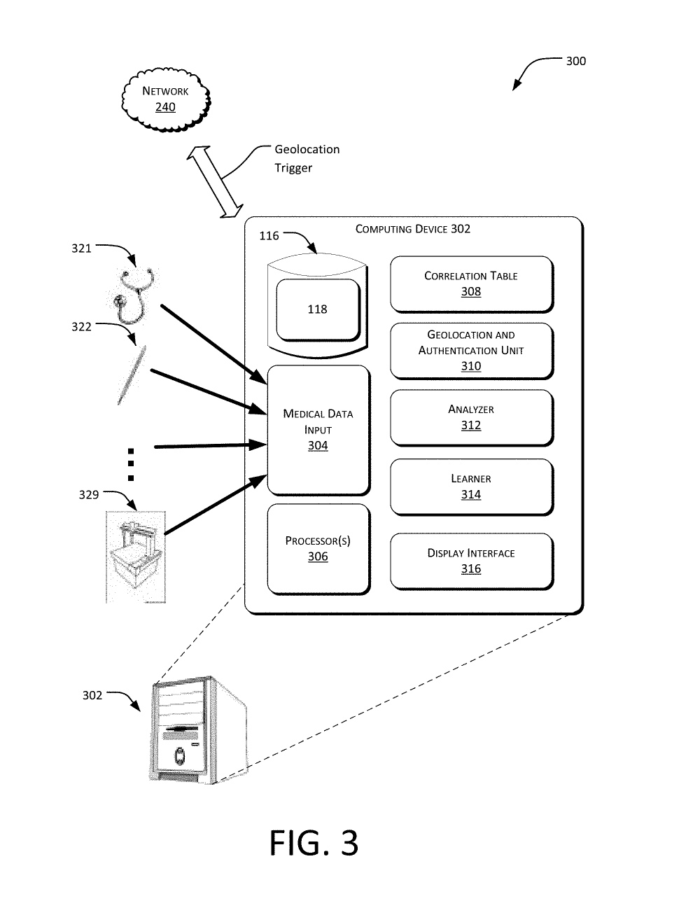

FIG. 3 illustrates an example system 300 of the cloud-based service as described in present implementations herein. The system 300 includes one or more computing devices 302 that may receive various medical data sources 321-329 either directly from the medical diagnostic tools, or through the network 240. The computing device 102 may further include: the data structure 116 with one or more digital patient medical database segments 118; a medical data input 304; one or more processor(s) 306, a correlation table 308, a geolocation and authentication unit 310, an analyzer 312, a learner 316, and a display interface 316. These functional components may be separate or some combination of hardware units. Alternatively, the components may be implemented, at least in part, via software and thus be stored in a memory and executed by the processors 306.

Using the system 300, the medical data input 204 acquires or receives patient information (or patient medical data) from one or more various medical data sources 321-329. The medical data sources 321-329 may include measurements such as X-ray results, body temperature, summary of multiple body scans, etc. The medical data input 304 may similarly receive healthcare diagnosis, recommended treatment, physician's notes to the patient, results of the various medical data sources 321-329, and the like, through the network 240. Since the various medical data sources 321-329 may continuously communicate data to the medical data input 204, the processor 306 may be configured to generate temporal patient medical data as may be necessary to the implementations described herein.

The patient information may be received by the medical data input 304 within a particular pre-configured time duration; within a time duration according to an authorization given by the patient; or may be limited by a contract with the patient; and/or the like. The information may be further received after the geolocation and the authentication unit 310 performs an identification and authentication process to make sure that the data is coming from the intended patient.

As depicted, the sources of medical data may include, but is not limited to, a vital signs monitors (such as stethoscope) 321, a thermometer 322, . . . and a X-ray machine 329. The medical data may be received directly from the respective measuring device itself, or may be received through the network 240 that may facilitate communication between the measuring devices and the computing device 302. When received directly from the measuring device, the information may be received through near field communications (NFC), Bluetooth (BT) communications, Wi-Fi, RFID, and the like. When received through the network 240, the sources of medical data may be transmitted, for example, by the computing device 204 that controls the medical diagnosis tool 202 in FIG. 2 above.

As an illustration, all medical diagnostic tools or equipment such as the X-ray machine 329, etc. have a reference base that deals in some way with the elemental makeup of the body. As described herein, the reference base may be utilized for an empirical data that may be collected to generate a (medical data) temporal information on the subject patient. That is, the processor 306 may be configured to compare multiple data from the same medical equipment to the medical equipment's standard reference base to generate, for example, an analysis of patient data and/or temporal information on the subject patient. Furthermore, the empirical data may be utilized by the processor 306 for correlation with another application, data, etc. such as, but not limited to:
Scheduling tools e.g., patient appointment schedules, tasks checklists and calendars, practice management schedulers, etc.;
Electronic and portable health records;
Document archives;
Fitness applications;
Nutrition applications;
Messaging and communication tools such as automatic email to the patient, SMS, etc.;
Media players;
Consumer review sites;
Search engines subject to consent of the patient;
Financial reporting and manipulation applications;
Cameras;
Social media applications;
Pharmacopeia, medical compendia and other healthcare content libraries;
Medical advice systems;
SMS Alerts such as the patient is within range of a healthcare provider, patient is in a dangerous location where allergies are high, etc.;
Calculators;
Clinical Decision Support tools;
Electronic-prescribing capabilities;
Medical education media, atlases and continuing education materials;
Research portals;
Radiology image capture, display and interpretation systems;
Accessories for intake of physiologic measurements, body fluids and other anatomic samples for processing and analysis, including for diagnostic and therapeutic purposes;
Telemedicine programs;
Payment processing applications;
Workflow tools;
Genomic libraries;
Buttons, touchscreens, microphones, speakers, ports and physical housing which permit both privacy and additional forms of connectivity; and/or the like.

The applications enumerated in the foregoing may utilize the empirical data stored on the digital patient medical data segments 118 as described herein and furthermore, the processor 306 may be configured to implement the enumerated applications, correlations of these applications, or the combination of these applications.

The medical data as used herein includes, at the very least, data measurements regarding one or more organs/tissues of the subject patient. In some implementations, other medical data from one or more other sources may be used, combined, and/or correlated with the previously taken data.

Initially, for example, medical data from a nominally normal person is gathered to generate the baseline model. In this example, the organs/tissues of the normal person and respective identifications of the organs/tissues, healthcare medical diagnosis information of the organs/tissues, measurements, etc. may be received through the medical data input 304. In this example still, the baseline model for the normal person is stored in the data structure 116. The baseline model is associated with the patient, who is the normal person discussed herein.

At another time instant, another set of medical data may be received through the medical data input 304. For example, some event or events occur that converts the otherwise normal person into a nominally abnormal person (i.e., unhealthy person). Such events may include stress inductions, food intake or exposure to chemical, biological, or radiological influences, discovery of a medical condition (such as cancer), or anything else that will cause a biological or medical difference between the normal person and the abnormal person. In this example, the subject patient may undergo another medical checkup and another set of data measurements may be received and gathered by the medical data input 304.

Based from the received another set of medical data, the processor 306 of the system 300 may associate the new set of data measurements corresponding to the identified one or more organs/tissues of the subject patient. Furthermore, the new set of data measurement are stored in a subsequent model in the same digital patient medical database segments 118 associated to the subject patient. The subsequent model is associated with the patient, who is both the normal and abnormal person discussed herein.

As described herein, the analyzer 312 may be configured to perform analysis of the baseline model and the subsequent model (which are found in the database 116). The analyzer 312 may further perform filtering of the baseline models to make use of relevant and up-to-date data (as opposed to old data measurements, etc.). For example, the analyzer 312 may utilize the correlation table 308 to derive standard pre-configured medical conclusions, temporal information, etc. that may result from comparing and contrasting different data measurements at desired different periods of time by the correlation table 308. To this end, in the example above, the analyzer 312 records (or highlights or notes) the differences between the baseline and the subsequent models. Although the illustration as described in this example refers to comparison of two sets of baseline models, multiple medical data from the various medical data sources 321-329 and/or received through the network 240 may be compared and contrasted by the correlation table 308.

In an implementation, the display interface 316 notes these differences to the healthcare personnel 102, accountant 104, the patient 110, and other persons who may have the authority to receive and view the medical data of the patient 110. In this implementation, a detection of the patient's geolocation by the geolocation and authentication unit 310 may trigger the sending of these notes to the patient 110 himself, healthcare personnel 102, accountant 106, etc. The triggering and other conditions may be found in the Table-One as illustrated above.

For example, the geolocation and authentication unit 310 continuously tracks the geolocation of the patient or alternatively, a geolocation trigger is received through the network 240 when the patient is at a particular geolocation such as in a nearby pharmacy. In this example, the geolocation and authentication unit 310 may first perform authentication of the user-device 112 and the patient himself.

In response to identified and authenticated patient 110, the learner 314 may be configured to find the particular digital patient medical database segment 118 that corresponds to the patient 110. For example, the learner 314 find the “Table-One” shown above as the particular digital patient medical database segment 118 that corresponds to the patient 110. In this example, the alert conditions, identification condition of the patient, temporal information on the medical data of the patient, etc. may be implemented accordingly by the processor 306.

For example, one of the data as shown in the “Table-One” triggers a SMS alert to the patient to buy the prescribed medicine when the patient 110 is detected to be in a nearby pharmacy. In this example, when the patient 110 selects this listing from his user-device 108, other conditions in the “Table-One”such as an alert to the accountant, insurer, etc. may be further implemented.

Stated in another way, the system 300 may be described as including (for example) the following:
an input system (e.g., medical data input 304) configured to obtain medical data of the subject patient;
a correlation table (e.g., correlation table 308) configured to compare and contrast multiple medical data input based upon the base reference for each medical equipment used, based from the medical diagnosis of the healthcare personnel, based from pre-configured standard diagnostic conclusion due to changes in measurements of a particular organ/tissue, etc.;
an analyzer (e.g., analyzer 312) configured to perform analysis of correlated data and to generate temporal information of the subject patient;
a display interface (e.g., display interface 316) configured to report the determined temporal information to the patient 110, healthcare personnel 102, etc.

In other implementations, the analyzer 312 may automatically generate a report regarding the likelihood of particular medical diagnoses. This may be accomplished (in whole or in part) by heuristics provided by medical professionals. In addition or in the alternative, this may be accomplished by using machine-learning techniques. In these implementations, the medical diagnosis (and/or suggested treatments) is uploaded to the digital patient medical database segments 118 and/or reported or documented via the display interface 316 to the medical professional and/or the patient as may be required by the pre-configured instructions such as the “Table-One” above. In certain implementations, patients and patient data (e.g., geo location, etc.) are inspected and patterns of geo-utilization are found. Such data may be associated with known (predetermined diagnosis and outcomes. With the identification of machine-learned patterns, geo-location behavior can be transformed into diagnoses, probability of disease progression, health care outcomes and needs.

In this other implementation, the analyzer 312 may further generate data to the “Table-One” where the data may be used to:
Review patient medical history;
Identify opportunities or gaps in patient care;
Prioritize interventions (based on temporal urgency or other metrics);
Revise treatment plans of the patient based on newly received medical data;
Deliver just-in-time care within the physical environment of the patient's current geolocation;
Substantiate physical presence or co-location of more than one tracked individual interacting in the care of one or more patients, including time stamping of the initiation, duration and termination of physical presence in a geolocation of interest;
Document the completion of steps or actions in a patient's care using the time, place and identity of the actors (e.g., medical doctor, accountant, etc.) involved in the steps or actions;
Allocate resources based on predictions of a patient's physical presence at a point of care using geo-temporal information that is updated continuously in real time, including possible use of waypoints along a patient's trajectory;
Pre-authorizing or prescribing care based on knowledge of a patient's known or expected presence at a point of service or point of care;
Inferring patient behavior and providing opportunities for behavioral modification, based on patient physical movements in the context of the patient's health status or evidence of patient noncompliance or indecision;
Delivering provisions, supplies, medications or other materials to individuals actual location that may change in real-time;
Facilitating mobile delivery care systems which deploy caretakers and resources to the location of a patient rather than requiring patients to obtain care at fixed points of service; and the like.

In the context of tracking the patient by the geolocation and authentication unit 310, the steps may involve the following:
an action of identifying the patient with confirmation of the identity and authentication of an observer's right to know the geolocation and temporal information of the observed patient. An observer can be a human being such as the primary physician of the patient 110, an organization, a device, software system, government, or other entity;
an action of identifying the tracked patient's geolocation along with temporal information and displaying it to the observer. This may occur by an action of the observer to seek the patient's temporal information (i.e., “pull” method), or may be automatically delivered to the observer based on preset authorization and clinical reasoning for the observer obtaining the information (i.e., “push” method);
an action which displays to the observer contextual information (demographics, psychographics, other clinical history, current medications, known prior medical conditions, etc.) that, where appropriate, is modified in scope or content by the analyzer 312 to reflect the whereabouts of the observed individual at the time(s) of the observation(s);
an action which provides the observer with action items that the observer may select in order to use the geolocation, temporal data, and contextual information in the process of delivering, measuring, assessing or auditing care; and
a feedback component that allows the observer to gauge, measure, track and/or assess the accuracy and usefulness of the geolocation and temporal information.

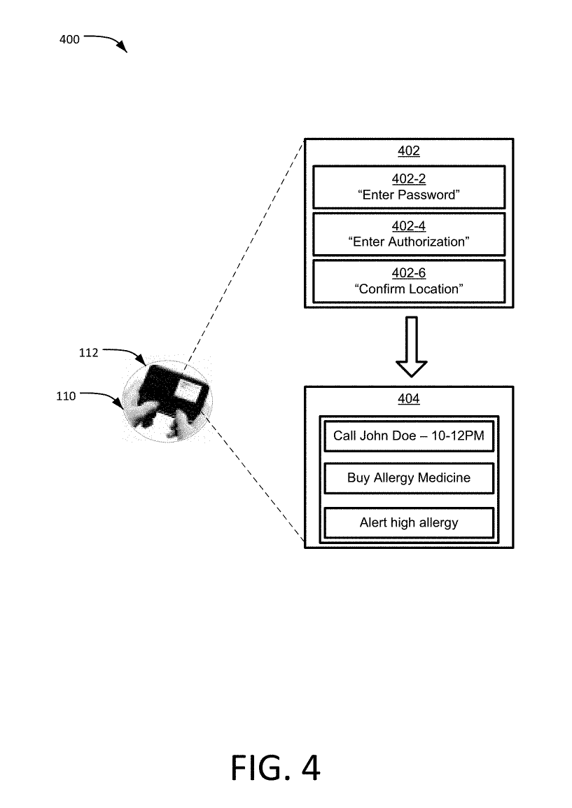

FIG. 4 illustrates an example screen-shot 400 on the user-device 112 of the patient 110 in response to the detected geolocation of the user-device. As shown, the screen-shot 400 includes a listing 402 that may be used for identification and authentication of the user-device 112 and/or the patient 110, and a listing 404 that may be used to present the alerts, recommendations, and other temporal information to the patient 110.

For example, using the display interface of the user-device 112, the patient 110 may first enter password, authorization, and/or confirm the detected geolocation. Thereafter, the patient may select the options at the listing 404 that the he/she may want to follow. The selected options may trigger other conditions in the digital patient medical database segments 118 as illustrated in the “Table-One” above and furthermore, the digital patient medical database segments 118 may be updated by the processor 306 accordingly.

In a preferred embodiment, the patient 110 who is in physical possession of the geolocation-enabled device experiences tailored clinical care based on physical proximity to or colocation with a healthcare provider. The tailored clinical care is based on the ability of the provider to use previously available and/or computed information pertinent to the specific patient on a temporal “just-in-time” basis. The proximity of the patient to the point of care may further allow the provider(s) to make adjustments to a treatment plan, for example, or pre-order laboratory tests, prescriptions, X-rays, or other interventions based on the fact that the patient is demonstrably in physical proximity for a scheduled or unscheduled clinical encounter, with a calculable lead-time derived from the patient's current geolocation and anticipated destination.

In another embodiment, the patient 110 who is in physical possession of the geolocation-enabled device may be able to identify points of care in proximity which provide needed and/or prescribed medical services based on data available on the patient. For example, the prescribed—physical therapy by a provider to the patient via an electronic prescription method can automatically be served information on the geolocation-enabled device to guide the patient to the proper physical therapy delivery location, and perhaps schedule the appointment with the facility using the same application. Quality of care measures may have different points of service (“nodes” on a dense network of locations) for different task completion.

For example, the pharmacy 120 may be the appropriate point of care for certain prescribed therapies, whereas a radiology center, primary care physician's office, nursing facility or home health agency, behavioral or psychiatric health clinic, ambulatory surgery center, hospital, or other location may be the appropriate “node” for delivery of the necessary care to satisfy quality of care metrics. It is to be understood, that the various use scenarios described may be automated or machine generated.

In another embodiment, the patient's physical presence at a point of care is recorded into a record that can be used to substantiate the duration of an encounter or to validate the existence of such an encounter. In certain implementations, the following may be tracked/recorded: behavior, pattern, performance of parties, such as healthcare providers, healthcare services, facilities, users, etc. For example, a patient undergoing a new patient visit in a physician's office must be seen for a proscribed minimum length of time for the physician to bill a claim for the encounter to the patient's health insurance, if the provider is billing based on time (as opposed to billing based on codified history and physical exam documentation requirements). In such a scenario, the length of time the patient is present in an examination room, potentially supplemented by data on the length of time the physician is present in the same narrow geolocation radius, can be used as substantiating information in a medical record or billing claim. Detection of an appropriate threshold of ‘encounter’ time can be used to automatically validate a medical record or bill.

In another embodiment, records that document the physical presence of a patient in a specific geolocation can be used by healthcare insurance auditors, attorneys, provider offices, and others, to audit and authenticate the presence of the patient in a specific location at a known date and time. The record can display the location of service and corroborating information from the device that attests to the patient's physical presence and duration thereof at the location. The record can also be automatically compared to the patient's prior locations and patterns to identify unexplained health resource utilization and serve as a method to report erroneous or fraudulent events. Such an alert is described above.

In another embodiment, patient behaviors can be deduced from frequent geolocation at places where certain activities, risk exposures, or encounters are likely, and rate of change of location (speed) may also be deduced. Examples might include geolocation of a patient in the driver's seat of a vehicle whose velocity on the freeway significantly exceeds speed limits; identification of frequent visits to liquor stores (negative exposure), health food grocery stores (positive exposure) or other venues where exposure to health-modifying behaviors is enabled; etc. Opportunities for behavioral modification or coaching may be identified for care providers.

In another embodiment, a provider's office flow of patients during a day of clinical encounters can be adjusted in real-time with up-to-date geolocation information of the whereabouts of patients expected or known to be in the office or facility. Rooming of patients by medical staff, direction of patients to appropriate stations within a larger facility (e.g., laboratory, X-ray station, casting room in an orthopedic office, etc.) can be more precisely accomplished with minimal wasted time and better utilization of physical space and staff resources.

In another embodiment, proximity allows for record sharing among authorized parties, with multi-step authentication of identities. This may be achievable by detecting the physical geolocation of both parties' devices, and utilizing underlying software to help authenticate that a relationship between the parties exists which permits the transfer of the record data, with an additional step of thumbprint, retinal scan, or other biophysical identification by both parties.

The embodiments described in the foregoing may be implemented by the components of the computing device 302 as described in the system 300 of FIG. 3.

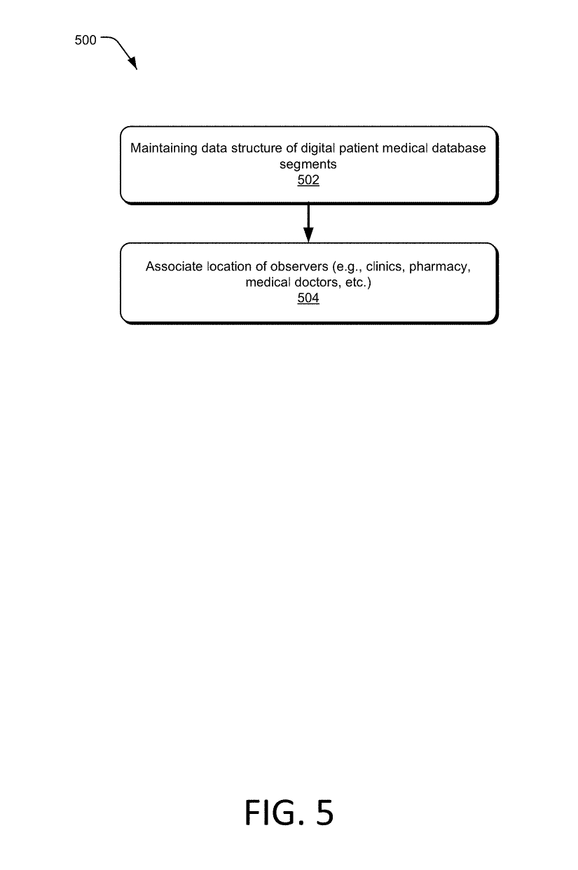

FIG. 5 illustrates an example flowchart 500 of configuring a device memory as described in present implementations herein. Particularly, the device memory stores the digital patient medical database segments 118 as described herein. The order in which the method is described is not intended to be construed as a limitation, and any number of the described method blocks may be combined in any order to implement the method, or alternate method. Additionally, individual blocks may be deleted from the method without departing from the spirit and scope of the subject matter described herein. Furthermore, the method may be implemented in any suitable hardware, software, firmware, or a combination thereof, without departing from the scope of the invention.

At block 502, maintaining data structure of digital patient medical database segments is performed. For example, one or more digital patient medical database segments 118 are stored in the data structure 116. In this example, the data structure 116 is located at cloud-based service 250. In another example, the digital patient medical database segments 118 are stored at the multimedia memory 208 of the user-device 112.

The one or more digital patient medical database segments 118 stored at the multimedia memory 208 of the user-device 112 or at the data structure 116 may include, but is not limited to: personal information records; and corresponding public health records, health insurance records, personal medical history records, personal medical care records, personal drug prescriptions records, healthcare organization and facility information, pharmacopeia data records, health care content libraries, government information records, marketing information libraries, and genomic libraries.

At block 504, associate location of observers is performed. For example, the observers may include individuals like the patient, healthcare personnel, accountants, etc. Alternatively, the observers may include places like clinics, hospitals, pharmacies, etc., or the observer may include entities like law firms, collecting agencies, and the like.

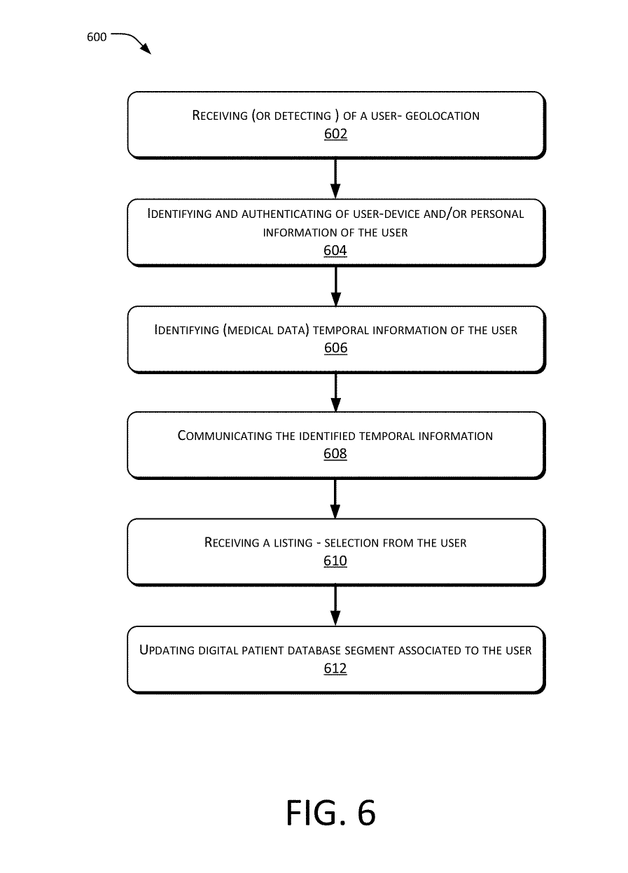

FIG. 6 illustrates an example flowchart 600 of implementing a method for a clinical-context aware precision medical care management as described herein. The order in which the method is described is not intended to be construed as a limitation, and any number of the described method blocks may be combined in any order to implement the method, or alternate method. Additionally, individual blocks may be deleted from the method without departing from the spirit and scope of the subject matter described herein. Furthermore, the method may be implemented in any suitable hardware, software, firmware, or a combination thereof, without departing from the scope of the invention.

At block 602, receiving of a geolocation of a patient is performed. For example, the geolocation and authentication unit 310 may receive the present location of the patient 110 through one or more wireless tracking technology such as, but not limited to, Global Positioning System (GPS), Bluetooth, Cellular Telephone, IEEE 801.11 (WiFi), and Radio Frequency Identification (RFID). In another example the present location may be received through personal tracking devices, physical monitoring devices, and the like.

At block 604, identifying and authenticating personal information of the patient is performed. For example, the geolocation and authentication unit 310 may be configured to perform identification and authentication of the patient 110. In this example, the conditions and/or requirements for the identification and authentication of the user-device and/or the patients may be retrieved from the one or more data stored on the digital patient medical database segments 118. In certain cases, validation of the geolocation pattern and supporting health and financial data may be used to automatically perform a prior authorization check and validation. No further paperwork would be needed for the patient to proceed (e.g., to the next test or medication or specialist visit).

At block 606, in response to a positive identification and authentication, identifying (medical data) temporal information of the patient is performed. For example, the analyzer 312 may be configured to generate temporal information such as patient alert, medical recommendations, etc. that may be retrieved from the digital patient medical database segments 118.

At block 608, communicating the temporal information to the patient is performed. For example, a transceiver component that is coupled to the processor 306 of the computing device 302 facilitates communication of the temporal information to the user-device 112.

At block 610, receiving of a listing selection from the patient is performed. For example, the patient 110 through his user-device 112 selects “buy prescription” data in the presented listing of temporal information. In this example, the temporal information includes up-to-date recommendations, alerts, etc. as illustrated in “Table-One” above.

At block 612, in response to the received selection, updating of the digital patient medical database segments 118 is facilitated by the processor 306. For example, the updating may further involve communication of the patient-selection to other observers such as the attending physician, the billing personnel, insurer, social worker, etc.

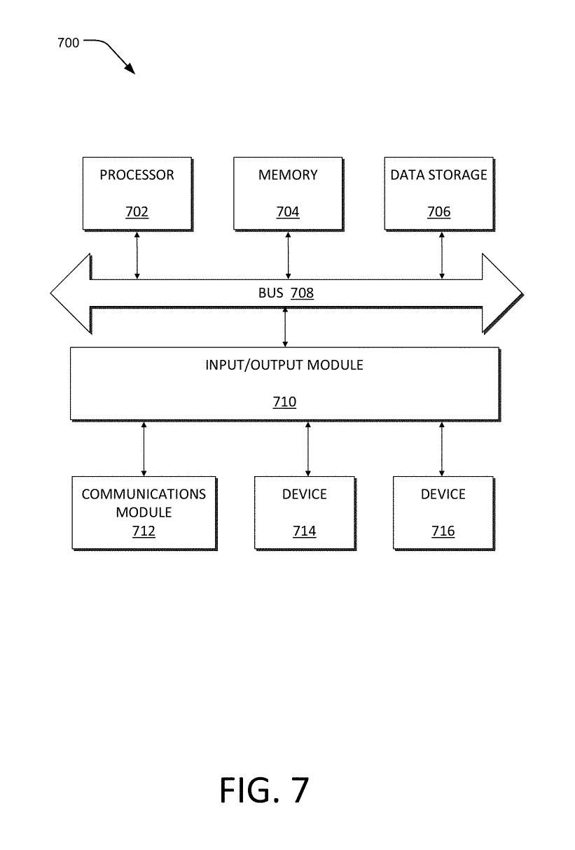

FIG. 7 is a block diagram illustrating an exemplary computer system 700 that may be utilized in the implementations as described herein. In certain aspects, the computer system 700 may be implemented using hardware or a combination of software and hardware, either in a dedicated server, or integrated into another entity, or distributed across multiple entities.

Computer system 700 includes a bus 708 or other communication mechanism for communicating information, and a processor 702 coupled with bus 708 for processing information. By way of example, the computer system 700 may be implemented with one or more processors 702.

Computer system 700 can include, in addition to hardware, code that creates an execution environment for the computer program in question, e.g., code that constitutes processor firmware, a protocol stack, a database management system, an operating system, or a combination of one or more of them stored in an included memory 704, such as a Random Access Memory (RAM), a flash memory, a Read Only Memory (ROM), a Programmable Read-Only Memory (PROM), an Erasable PROM (EPROM), registers, a hard disk, a removable disk, a CD-ROM, a DVD, or any other suitable storage device, coupled to bus 708 for storing information and instructions to be executed by processor 702. The processor 702 and the memory 704 can be supplemented by, or incorporated in, logic circuitry.

The methods and systems described herein may be deployed in part or in whole through a machine that executes computer software on a server, client, firewall, gateway, hub, router, or other such computer and/or networking hardware. The software program may be associated with a server that may include a file server, print server, domain server, internet server, intranet server and other variants such as secondary server, host server, distributed server and the like. The server may include one or more of memories, processors, computer readable media, storage media, ports (physical and virtual), communication devices, and interfaces capable of accessing other servers, clients, machines, and devices through a wired or a wireless medium, and the like. The methods, programs or codes as described herein and elsewhere may be executed by the server. In addition, other devices required for execution of methods as described in this application may be considered as a part of the infrastructure associated with the server.

The server may provide an interface to other devices including, without limitation, clients, other servers, printers, database servers, print servers, file servers, communication servers, distributed servers and the like. Additionally, this coupling and/or connection may facilitate remote execution of programs across the network. The networking of some or all of these devices may facilitate parallel processing of a program or method at one or more location without deviating from the scope of the disclosed subject matter. In addition, any of the devices attached to the server through an interface may include at least one storage medium capable of storing methods, programs, code and/or instructions. A central repository may provide program instructions to be executed on different devices. In this implementation, the remote repository may act as a storage medium for program code, instructions, and programs.

The methods and systems described herein may be deployed in part or in whole through network infrastructures. The network infrastructure may include elements such as computing devices, servers, routers, hubs, firewalls, clients, personal computers, communication devices, routing devices and other active and passive devices, modules and/or components as known in the art. The computing and/or non-computing device(s) associated with the network infrastructure may include, apart from other components, a storage medium such as flash memory, buffer, stack, RAM, ROM and the like. The processes, methods, program codes, instructions described herein and elsewhere may be executed by one or more of the network infrastructural elements.

The computer software, program codes, and/or instructions may be stored and/or accessed on machine readable media that may include: computer components, devices, and recording media that retain digital data used for computing for some interval of time; semiconductor storage known as random access memory (RAM); mass storage typically for more permanent storage, such as optical discs, forms of magnetic storage like hard disks, tapes, drums, cards and other types; processor registers, cache memory, volatile memory, non-volatile memory; optical storage such as CD, DVD; removable media such as flash memory (e.g. USB sticks or keys), floppy disks, magnetic tape, paper tape, punch cards, standalone RAM disks, Zip drives, removable mass storage, off-line, and the like; other computer memory such as dynamic memory, static memory, read/write storage, mutable storage, read only, random access, sequential access, location addressable, file addressable, content addressable, network attached storage, storage area network, bar codes, magnetic ink, and the like.

The elements described and depicted herein, including in flow charts and block diagrams throughout the figures, imply logical boundaries between the elements. However, according to software or hardware engineering practices, the depicted elements and the functions thereof may be implemented on machines through non-transitory computer executable media having a processor capable of executing program instructions stored thereon as a monolithic software structure, as standalone software modules, or as modules that employ external routines, code, services, and so forth, or any combination of these, and all such implementations may be within the scope of the present disclosure.

Thus, while the foregoing drawings and descriptions set forth functional aspects of the disclosed systems, no particular arrangement of software for implementing these functional aspects should be inferred from these descriptions unless explicitly stated or otherwise clear from the context. Similarly, it will be appreciated that the various techniques identified and described above may be varied, and that the order of techniques may be adapted to particular applications of the techniques disclosed herein. All such variations and modifications are intended to fall within the scope of this disclosure. As such, the depiction and/or description of an order for various techniques should not be understood to require a particular order of execution for those techniques, unless required by a particular application, or explicitly stated or otherwise clear from the context.

The methods and/or processes described above, and techniques thereof, may be realized in hardware, or any combination of hardware and software suitable for a particular application. The hardware may include a general purpose computer and/or dedicated computing device or specific computing device or particular aspect or component of a specific computing device. The processes may be realized in one or more microprocessors, microcontrollers, embedded microcontrollers, programmable digital signal processors or other programmable device, along with internal and/or external memory. The processes may also, or instead, be embodied in an application specific integrated circuit, a programmable gate array, programmable array logic, or any other device or combination of devices that may be configured to process electronic signals. It will further be appreciated that one or more of the processes may be realized as a computer executable code capable of being executed on a machine readable medium.

The instructions may be stored in the memory 704 and implemented in one or more computer program products, i.e., one or more modules of computer program instructions encoded on a computer readable medium for execution by, or to control the operation of, the service 100, and according to any method well known to those of skill in the art, including, but not limited to, computer languages such as data-oriented languages (e.g., SQL, dBase), system languages (e.g., C, Objective-C, C++, Assembly), architectural languages (e.g., Java, .NET), and application languages (e.g., PHP, Ruby, Perl, Python).

A computer program as discussed herein does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, subprograms, or portions of code). A computer program can be deployed to be executed on one computer or on multiple computers that are located at one site or distributed across multiple sites and interconnected by a communication network. The processes and logic flows described in this specification can be performed by one or more programmable processors executing one or more computer programs to perform functions by operating on input data and generating output.

Computer system 700 further includes a data storage device 706 such as a magnetic disk or optical disk, coupled to bus 708 for storing information and instructions. Computer system 700 may be coupled via an input/output module 710 to various devices. The input/output module 710 can be any input/output module. Example input/output modules 710 include data ports such as USB ports. The input/output module 710 is configured to connect to a communications module 712. Example communications modules 712 include networking interface cards, such as Ethernet cards and modems. In certain aspects, the input/output module 710 is configured to connect to a plurality of devices, such as an input device 714 and/or an output device 716. Example input devices 714 include a keyboard and a pointing device, e.g., a mouse or a trackball, by which a user can provide input to the computer system 700. Other kinds of input devices 714 can be used to provide for interaction with a user as well, such as a tactile input device, visual input device, audio input device, or brain-computer interface device. For example, feedback provided to the user can be any form of sensory feedback, e.g., visual feedback, auditory feedback, or tactile feedback; and input from the user can be received in any form, including acoustic, speech, tactile, or brain wave input. Example output devices 716 include display devices, such as a CRT (cathode ray tube) or LCD (liquid crystal display) monitor, for displaying information to the user.

According to one aspect of the present disclosure, the system for associating a file type with an application as shown in FIGS. 1-2, can be implemented using a computer system 700 in response to processor 702 executing one or more sequences of one or more instructions contained in memory 704. Such instructions may be read into memory 704 from another machine-readable medium, such as data storage device 706. Execution of the sequences of instructions contained in main memory 704 causes processor 702 to perform the processes described herein. One or more processors in a multi-processing arrangement may also be employed to execute the sequences of instructions contained in memory 704. In alternative aspects, hard-wired circuitry may be used in place of or in combination with software instructions to implement various aspects of the present disclosure. Thus, aspects of the present disclosure are not limited to any specific combination of hardware circuitry and software.

Various aspects of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. The communication network can include, for example, any one or more of a personal area network (PAN), a local area network (LAN), a campus area network (CAN), a metropolitan area network (MAN), a wide area network (WAN), a broadband network (BBN), the Internet, and the like. Further, the communication networks can include, but are not limited to, for example, any one or more of the following network topologies, including a bus network, a star network, a ring network, a mesh network, a star-bus network, tree or hierarchical network, or the like. The communications modules can be, for example, modems or Ethernet cards.

As discussed above, computing system 700 can include clients and servers. A client and server are generally remote from each other and typically interact through a communication network. The relationship of client and server arises by virtue of computer programs running on the respective computers and having a client-server relationship to each other. Computer system 700 can be, for example, and without limitation, an enterprise server or group of servers, one or more desktop computers, one or more laptop computers, etc. Computer system 700 can also be embedded in another device, for example, and without limitation, a mobile telephone, a personal digital assistant (PDA), a mobile audio player, a Global Positioning System (GPS) receiver, a video game console, and/or a television set top box.

The term “machine-readable storage medium” or “computer readable medium” as used herein refers to any medium or media that participates in providing instructions to processor 702 for execution. Such a medium may take many forms, including, but not limited to, non-volatile media, volatile media, and transmission media. Non-volatile media include, for example, optical or magnetic disks, such as data storage device 706. Volatile media include dynamic memory, such as memory 704. Transmission media include coaxial cables, copper wire, and fiber optics, including the wires that comprise bus 708. Common forms of machine-readable media include, for example, floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH EPROM, any other memory chip or cartridge, or any other medium from which a computer can read. The machine-readable storage medium can be a machine-readable storage device, a machine-readable storage substrate, a memory device, a composition of matter effecting a machine-readable propagated signal, or a combination of one or more of them.

While this specification contains many specifics, these should not be construed as limitations on the scope of what may be claimed, but rather as descriptions of particular implementations of the subject matter. Certain features that are described in this specification in the context of separate implementations can also be implemented in combination in a single implementation. Conversely, various features that are described in the context of a single implementation can also be implemented in multiple implementations separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

While operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the aspects described above should not be understood as requiring such separation in all aspects, and it should be understood that the described program components and systems can generally be integrated together in a single software product or packaged into multiple software products.

The subject matter of this specification has been described in terms of particular aspects, but other aspects can be implemented and are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous. Other variations are within the scope of the following claims.

In the claims appended herein, the inventors invoke 35 U.S.C. §112, paragraph 6 only when the words “means for” or “steps for” are used in the claim. If such words are not used in a claim, then the inventors do not intend for the claim to be construed to cover the corresponding structure, material, or acts described herein (and equivalents thereof) in accordance with 35 U.S.C. §112, paragraph 6.

What is claimed is:

1. A medical service system comprising:
communication to one or more communication devices that track and determine physical locations of patients; and
one or more servers configured to receive the physical locations of the patients from the one or more communication devices, wherein the one or more servers access personal medical data related to each of the patients and correlate the personal medical data to physical location of each of the patients.

2. The medical service system of claim 1, wherein the one or more communication devices that track and determine physical locations of patients comprise at least one wireless tracking technology from Global Positioning System (GPS), Bluetooth, Cellular Telephone, IEEE 801.11 (WiFi), and Radio Frequency Identification (RFID).

3. The medical service system of claim 1, wherein the one or more communication devices that track and determine physical locations of patients comprise cellular telephones, computing devices, personal tracking devices, and physical monitoring devices.

4. The medical service system of claim 1, wherein the one or more servers access personal medical data from one or more databases.

5. The medical service system of claim 4, wherein information in the one or more databases comprise one or more of the following: personal information records, public health records, health insurance records, personal medical history records, personal medical care records, personal drug prescriptions records, healthcare organization and facility information, pharmacopeia data records, health care content libraries, government information records, marketing information libraries, and genomic libraries.

6. The medical service system of claim 1, wherein physical location of each of the patients is related to a health service action.

7. The medical service system of claim 1, wherein the one or more servers further provide personal medical data and physical data location related to each of the patients to health care providers that is used for medical service of each of the patients.

8. The medical service system of claim 7, wherein the physical data location to each of the patients is provided to other parties including succeeding health care providers.

9. The medical service system of claim 7, wherein the health care providers are authenticated as to ability to receive physical data location to each of the patients.

10. The medical service system of claim 7, wherein the health care providers are authorized by each of the patients as to ability to receive physical data location specific to each of the patients.

11. The medical service system of claim 7, wherein each of the patients are confirmed as to authorization of health care providers to receive physical data location as to each of the patients.

12. The medical service system of claim 7 further comprising updating a patient's personal information based on a visit to one or more or the health care providers.

13. The medical service system of claim 1, wherein the one or more servers further provide one or more of predetermined diagnosis, probability of disease progression, health care outcome, and patient needs, as to location of each of the patients.

14. The medical service system of claim 1, wherein the one or more servers further identifies particular patient care as to patients depending on personal medical data related to physical location of each of the patients.

15. The medical service system of claim 1, wherein the one or more servers further notifies interested third parties.

16. The medical service system of claim 1, wherein the one or more servers further provides alerts related to one or more of the following: prescriptions; medical claims regarding service; duration of expected medical service, correlation of service as to determined geolocation of patient, context of service billed as to determined geolocation of patient; an alert as to expected time of service over a determined timeframe; geolocation inconsistent with other information; inconsistent location of provider as to geolocation of patient.

17. A device comprising:
one or more processors;
a transceiver component coupled to the one or more processors;
and memory coupled to the one or more processors and the transceiver, configured to:
receive from the transceiver component, physical locations of a plurality of patients as determined by communication devices associated with the each of the plurality of patients;
receive from the transceiver component, personal medical data related to each of the plurality of patients, and
correlate the personal medical data related to each of the plurality of patients to physical locations of each of the plurality of patients.

18. The device of claim 17, wherein the memory is further configured to review medical history of each of the patients as provided in the personal medical data.

19. The device of claim 17, wherein the memory is further configured to determine care of each of the patients as provided in the personal medical data.

20. The device of claim 17, wherein the memory is further configured to determine treatment of each of the patients as provided in the personal medical data based on time of determining physical locations of each of the plurality of patients.

21. The device of claim 17, wherein the memory is further configured to authorize care of each of the patients as provided in the personal medical data.

22. The device of claim 17, wherein the memory is further configured to provide the physical locations of each of the plurality of patients and time when the physical locations were determined.

23. The device of claim 17, wherein the memory is further configured to update personal health care records based on visits to one or more health care providers.

24. The device of claim 17, wherein the memory is further configured to determine if medical supplies, care, and/or medication is to be or has been provided to each of the plurality patients based on the physical locations of each of the plurality of patients and time when the physical locations were determined.

25. The device of claim 17, wherein the memory is configured to perform the acts of, or further comprising components related to one or more of the following:
Identification and authentication components
Scheduling tools (Calendars, practice management schedulers, task checklists and others)
Electronic and portable health records
Prescription records
Document archives
Fitness applications
Physiology sensors
Nutrition applications
Messaging and communication tools (email, SMS, internet- and wifi-based messaging, among others)
Media players
Consumer review sites
Search engines
Financial reporting and manipulation applications
Cameras
Social media applications
Pharmacopias, medical compendia and other healthcare content libraries
Medical advice systems
Alerts
Calculators
Clinical Decision Support tools
Electronic-prescribing capabilities
Medical education media, atlases and continuing education materials
Research portals
Radiology image capture, display and interpretation systems
Accessories for intake of physiologic measurements, body fluids and other anatomic samples for processing and analysis, including for diagnostic and therapeutic purposes
Telemedicine programs
Payment processing applications
Workflow tools
Genomic libraries

26. Non-transient computer readable media configured to perform a method comprising:
determining physical locations of patients;
accessing medical data related to the patients;
correlating physical location and medical data of the patients; and
assessing medical care to be provided to patients based on the physical location and medical data.

27. The non-transient computer readable media of claim 26 wherein the determining is performed using at least one wireless tracking technology from Global Positioning System (GPS), Bluetooth, Cellular Telephone, IEEE 801.11 (WiFi), and Radio Frequency Identification (RFID).

28. The non-transient computer readable media of claim 26 wherein the non-transient computer readable media is configured to be processed on one or more of cellular telephones, computing devices, personal tracking devices, and physical monitoring devices.

29. The non-transient computer readable media of claim 26 wherein the accessing medical data is from one or more of the following: personal information records, public health records, health insurance records, personal medical history records, personal medical care records, personal drug prescriptions records, healthcare organization and facility information, pharmacopeia data records, health care content libraries, government information records, marketing information libraries, and genomic libraries.

30. The non-transient computer readable media of claim 26 wherein the physical locations are directed to a health service action.

31. The non-transient computer readable media of claim 26 further comprising providing medical data and physical data location related to each of the patients to health care providers that is used for medical service of each of the patients.

32. The non-transient computer readable media of claim 26 further comprising providing physical data location to each of the patients to other parties including succeeding health care providers.

33. The non-transient computer readable media of claim 32, wherein the health care providers are authenticated as to ability to receive physical data location to each of the patients.

34. The non-transient computer readable media of claim 26 further comprising providing particular patient care as to patients depending on personal medical data related to physical location of each of the patients.

35. The non-transient computer readable media of claim 26 comprising updating a patient's personal information based on a visit to one or more or the health care providers.

36. A method performed on a device comprising:
receiving physical locations of a plurality of patients as determined by communication devices associated with the each of the plurality of patients;
receiving personal medical data related to each of the plurality of patients, and
correlating the personal medical data related to each of the plurality of patients to physical locations of each of the plurality of patients.

37. The method of claim 36 further comprising reviewing medical history of each of the patients as provided in the personal medical data.

38. The method of claim 36 further comprising determining care of each of the patients as provided in the personal medical data.

39. The method of claim 36 further comprising determining treatment of each of the patients as provided in the personal medical data based on time of determining physical locations of each of the plurality of patients.

40. The method of claim 36 further comprising authorizing care of each of the patients as provided in the personal medical data.

41. The method of claim 36 further comprising providing the physical locations of each of the plurality of patients and time when the physical locations were determined.

42. The method of claim 36 further comprising updating personal health care records based on visits to one or more health care providers.

43. The method of claim 36 further comprising determining if medical supplies, care, and/or medication is to be or has been provided to each of the plurality patients based on the physical locations of each of the plurality of patients and time when the physical locations were determined.
